(19) United States
(12) Patent Application Publication
(10) Pub. No.: US 2006/0222237 A1
(43) Pub. Date: Oct. 5, 2006

(54) Method and apparatus for inspecting an object after stamping

(75) Inventors: Ruxu Du, Hong Kong (CN); Maolin Yu, Hong Kong (CN); Yiu-Ming Harry Ng, Hong Kong (CN); Wai Hung Harry To, Hong Kong (CN)

Correspondence Address: DARBY & DARBY P.C., P. O. BOX 5257, NEW YORK, NY, 10150-5257, US

(73) Assignees: The Chinese University of Hong Kong, Hong Kong (CN); Mansfield Manufacturing Co., Ltd., Hong Kong (CN)

(21) Appl. No.: 11/347,510

(22) Filed: Feb. 2, 2006

(30) Foreign Application Priority Data
Feb. 5, 2005 (CN) 200510007548.X

(51) Int. Cl. G06K 9/00

(52) U.S. Cl. 382/152

(57) ABSTRACT

A method and apparatus for inspecting an object after stamping is described. The method and apparatus comprises determining a temperature distribution of an object after stamping; obtaining one or more thermal images of the object after stamping; and comparing the determined temperature distribution with the obtained thermal images so as to identify defects existing in the object after stamping, in which the difference between the temperature distribution and the thermal images indicates the presence of defects in the object. The method and apparatus can therefore inspect and analysis problems of the object occurred during the stamping process.

### CROSS REFERENCE OF RELATED APPLICATIONS

The present application claims the benefit of Chinese Patent application No. 200510007548.X filed on Feb. 5, 2005, entitled the same, which is explicitly incorporated herein by reference in its entirety.

### BACKGROUND OF THE INVENTION

1. Field of the Invention

This invention relates to metalworking, and more particularly to a method and apparatus for inspecting an object after stamping.

2. Description of the Prior Art

A process for stamping an object is very complex, which relates to an instantaneous elastic and plastic deformation of the object, and a static and dynamic behavior of a stamping press. The stamping process may be affected by many factors, such as a stamping press, a die, an object, and stamping conditions (e.g., pressing speed, lubricating property, etc.). Nowadays, in order to reduce costs of production, a metal stamping process is often carried out under an extreme condition (including over-utilization of a geometric shape, a pressing speed, and a stamping power). Thus, various defects, such as improper size, crack and wrinkle, are prone to occur. However, currently there has no scientific method to detect which causes the defects.

Some commercially available software packages, such as LS-DYNA® and PAMSTAMP®, are provided to calculate a strain and stress distribution during the metal stamping process by means of Finite Element Analysis (FEA). However, the strain and stress distribution is calculated based on an ideal condition without considering practical situations, for example, manufacturing errors of a die (including machining error, assembly error and surface roughness), performance of the press (e.g., vibration), as well as stamping conditions (lubrication, friction). Hence, such calculation suffers from at least 25% error. Moreover, these methods cannot tell which causes the problems, and thus cannot take appropriate action to prevent reoccurrence of the problems.

The present invention is presented to solve the abovementioned disadvantages in the prior art.

### BRIEF SUMMARY OF THE INVENTION

It is an object of the present invention to provide a method and an apparatus for inspecting an object after stamping, so that a distortion of the object can be detected.

According to a first aspect of the present invention, a method for inspecting an object after stamping is provided, which comprises:

obtaining one or more thermal images of the object after stamping; and

inspecting defects of the object after stamping by analyzing the one or more thermal images, wherein an abnormal temperature distribution in the one or more thermal images, shown by absence of a smooth temperature gradient in thermal images, indicates that problems exist in the object during the stamping process.

According to a second aspect of the present invention, a method for inspecting an object after stamping is provided, which comprises:

determining a temperature distribution of the object after stamping;

obtaining one or more thermal images of the object after stamping; and

inspecting defects of the object after stamping by comparing the temperature distribution with the one or more thermal images,

wherein the difference between the temperature distribution and the thermal image indicate that problems exist in the object during the stamping process.

In an embodiment of the present invention, the determining a temperature distribution of the object after stamping comprises modeling the stamping process.

In another embodiment of the present invention, the modeling the stamping process is performed by using a finite element analysis model.

In a further embodiment of the present invention, the thermal images are obtained by an infrared camera. Preferably, the thermal images may comprise a plurality of thermal images which are captured in different directions with respect to the object.

According to a third aspect of the present invention, an apparatus for inspecting an object after stamping is provided, which comprises a device to obtain thermal images of the object after stamping.

In an embodiment of the present invention, the apparatus further comprises:

a device for determining temperature distribution of the object after stamping; and

a data processing device, which is electrically coupled to the device for determining temperature distribution of the object after stamping and the device to obtain thermal images of the object after stamping, for comparing the determined temperature distribution with the thermal images of the object after stamping.

In another embodiment of the present invention, the device for obtaining thermal images of the object after stamping includes a support mechanism for supporting and fixing the object after stamping; and an infrared camera for obtaining the thermal images and transferring the images to the data processing device.

In still another embodiment of the present invention, the device to obtain thermal images of the object after stamping further includes an adiabatic shell which has at least one side wall for mounting the infrared camera.

In an additional embodiment of the present invention, the device to obtain thermal images of the object after stamping may further comprise a driving mechanism for driving the support mechanism.

### BRIEF DESCRIPTION OF THE DRAWINGS

FIG. 1 is a view of a four-node quadrilateral element of an object to be modeled according to a finite element analysis model;

FIG. 2 is a view of a four-node quadrilateral element in a virtual space, in which the element corresponds to the four-node quadrilateral element of FIG. 1;

FIG. 3 is a view illustrating a cup made by one-step stamping process;

FIG. 4 is a view illustrating a calculated temperature distribution of the cup shown in FIG. 3 according to finite element analysis of the present invention;

FIG. 5 is a view illustrating an object made by progressive stamping process;

FIG. 6 shows a thermal image of the object of FIG. 5;

FIG. 7 is a block diagram of an inspecting method according to the present invention;

FIG. 8 is a schematic view of an inspecting apparatus according to the present invention;

FIG. 9 shows six thermal images of the cup of FIG. 3;

FIG. 10 shows reconstructed temperature distributions of the cup of FIG. 3 from different angles of view; and

FIG. 11 is a block diagram of FEA according to the present invention.

### DETAILED DESCRIPTION OF THE PREFERRED EMBODIMENTS

The present invention is based on the Law of Conservation of Energy. During a stamping process, an object is deformed by absorbing energy, and then the deformation energy is converted to heat energy. Therefore, a temperature distribution of the object (or a die, since the heat energy may be transmitted from the object to the die) is related to the deformation (strain and stress) of the object. In other words, the temperature distribution of the object describes where and how the object is deformed. Hence, by analyzing the temperature distribution of the formed object (or the die), it is possible to detect an excessively deformed (strain/stress) position, thereby inspecting which causes the problem.

At present, several commercial FEA (finite element analysis) software packages are available to calculate a stress and strain distribution of an object after stamping so as to inspect the object. However, there are still no FEA models for calculating a temperature distribution of the object after stamping.

In the present invention, a new method is provided for inspecting an object after stamping by using thermal imaging technology and an FEA method to calculate a temperature distribution of the object.

For a simple object, it is possible to detect a distortion of the object generated during the stamping process just by using thermal imaging technology. For example, we can take one or more infrared images of an object with a symmetric structure, if the temperature value reflected by the infrared images is not symmetric, there must be some defects during the stamping.

However, when the object is of a complicated structure, the infrared images may fail to completely mirror the temperature distribution of the object. In this case, we can calculate the temperature distribution of the object by using FEA so as to inspect the object by comparing the temperature distribution with the infrared images.

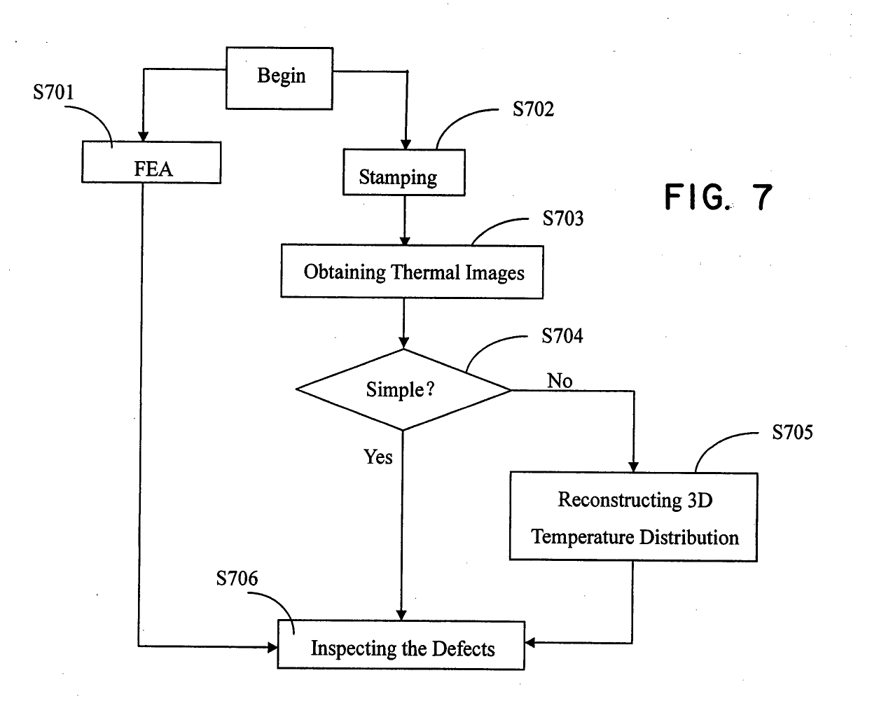

As shown in FIG. 7, inspecting defects of an object after stamping includes the steps of: calculating a temperature distribution of an object after stamping by using FEA (step S701); stamping the object (step S702); capturing one or more infrared images of the object reflecting a two-dimension (2D) temperature value of the object after stamping (step S703); determining whether the 2D temperature value reflected by the infrared images is of a relatively simple configuration, if it is, directly going to step S706, if it is not, going to step S705 (step S704); reconstructing a three-dimension (3D) temperature distribution of the object after stamping by using the 2D infrared images (step S705); and inspecting defects of the object by comparing the calculated temperature distribution of the object with the thermal images captured or with the reconstructed 3D temperature distribution (step S706).

Therefore, by easily comparing the calculated temperature distribution with the thermal images or with the reconstructed temperature distribution of the object, we can inspect and analyze problems generated during the stamping process.

FIG. 11 is a block diagram of FEA method for calculating the temperature distribution of the object. The FEA method of this embodiment comprises the following steps: creating and discretizing the object into finite elements, so that the object is sub-divided into elements and nodes (step S801); assuming a shape function to represent the physical behaviour of each element (step S802); developing heat equations for each element (step S803); applying boundary conditions and initial conditions (step S804); solving a set of algebraic equations simultaneously to obtain temperature values at different nodes (step S805); and obtaining a temperature distribution of the object (step S806).

The detailed procedures of FEA method for calculating the temperature distribution of the object is described as follows.

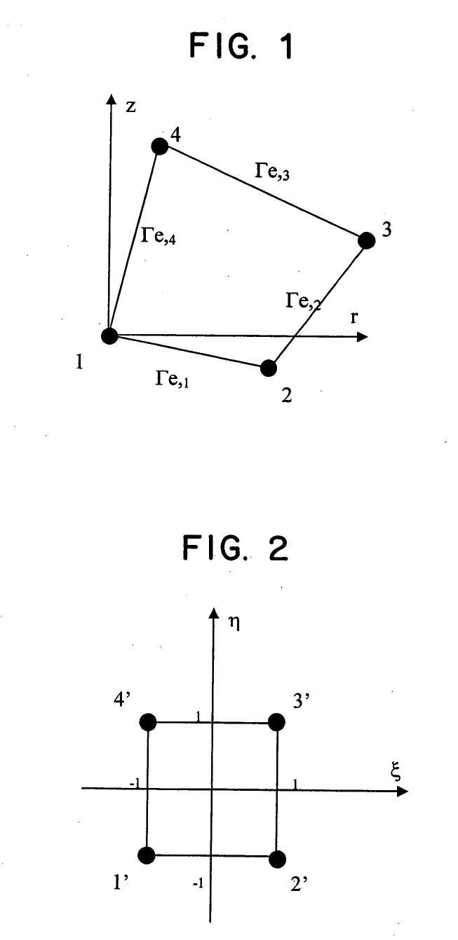

According to an embodiment of the present invention, the object is divided into a plurality of four-node quadrilateral elements. As shown in FIG. 1, each element is defined by four nodes associated with two coordinates, r and z., with one degree of freedom at each node, temperature, in which Γ_{e,1}, Γ_{e,2}, Γ_{e,3} and Γ_{e,4} are bounds of the element.

As shown in FIG. 2, the coordinate r and z in a physical space are mapped to two new coordinates ξ and η in a virtual space, respectively. That is, for the element in FIG. 2, the shape functions of the four nodes (i.e., 1′, 2′, 3′ and 4′) in the virtual space are:

$${N}_{1} = \frac{( 1 - ξ ) ( 1 - η )}{4}$$

$${N}_{2} = \frac{( 1 + ξ ) ( 1 - η )}{4}$$

$${N}_{3} = \frac{( 1 + ξ ) ( 1 + η )}{4}$$

$${N}_{4} = \frac{( 1 - ξ ) ( 1 + η )}{4} .$$

To transform the (ξ, η) system to the (r, z) system, the following equations is provided:

$$\frac{\partial {N}_{i}}{\partial ξ} = \frac{\partial {N}_{i}}{\partial r} \frac{ⅆ r}{ⅆ ξ} + \frac{\partial {N}_{i}}{\partial z} \frac{ⅆ z}{ⅆ ξ}$$

$$\frac{\partial {N}_{i}}{\partial η} = \frac{\partial {N}_{i}}{\partial r} \frac{ⅆ r}{ⅆ η} + \frac{\partial {N}_{i}}{\partial z} \frac{ⅆ z}{ⅆ η}$$

that is

$$\{ \begin{matrix}\frac{\partial {N}_{i}}{\partial ξ} \\ \frac{\partial {N}_{i}}{\partial η}\end{matrix} \} = [ \begin{matrix}\frac{ⅆ r}{ⅆ ξ} & \frac{ⅆ z}{ⅆ ξ} \\ \frac{ⅆ r}{ⅆ η} & \frac{ⅆ z}{ⅆ η}\end{matrix} ] \{ \begin{matrix}\frac{\partial {N}_{i}}{\partial r} \\ \frac{\partial {N}_{i}}{\partial z}\end{matrix} \}$$

the (2×2) matrix

$$[ {J}_{e} ] = [ \begin{matrix}\frac{ⅆ r}{ⅆ ξ} & \frac{ⅆ z}{ⅆ ξ} \\ \frac{ⅆ r}{ⅆ η} & \frac{ⅆ z}{ⅆ η}\end{matrix} ] .$$

It is possible to express the coordinates of any point of the element using the coordinates of nodes 1, 2, 3 and 4 of the element in the physical space as follows,
r(ξ,η)=N₁r₁+N₂r₂+N₃r₃+N₄r₄
z(ξ,η)=N₁z₁+N₂z₂+N₃z₃+N₄z₄
where rᵢ and zᵢ are coordinates of a node i.

Thereby, [Jₑ] becomes

$$[ {J}_{e} ] = [ \begin{matrix}\frac{ⅆ {N}_{1}}{ⅆ ξ} & \frac{ⅆ {N}_{2}}{ⅆ ξ} & \frac{ⅆ {N}_{3}}{ⅆ ξ} & \frac{ⅆ {N}_{4}}{ⅆ ξ} \\ \frac{ⅆ {N}_{1}}{ⅆ η} & \frac{ⅆ {N}_{2}}{ⅆ η} & \frac{ⅆ {N}_{3}}{ⅆ η} & \frac{ⅆ {N}_{4}}{ⅆ η}\end{matrix} ] [ \begin{matrix}{r}_{1} & {z}_{1} \\ {r}_{2} & {z}_{2} \\ {r}_{3} & {z}_{3} \\ {r}_{4} & {z}_{4}\end{matrix} ] = [ \begin{matrix}η - 1 & 1 - η & η & - η \\ ξ - 1 & - ξ & ξ & 1 - ξ\end{matrix} ] [ \begin{matrix}{r}_{1} & {z}_{1} \\ {r}_{2} & {z}_{2} \\ {r}_{3} & {z}_{3} \\ {r}_{4} & {z}_{4}\end{matrix} ]$$

we note that

$$[ {J}_{e} ] = [ \begin{matrix}{J}_{11} & {J}_{12} \\ {J}_{21} & {J}_{22}\end{matrix} ] {and \\ [ {J}_{e} ]}^{- 1} = [ \begin{matrix}{J}_{11}^{- 1} & {J}_{12}^{- 1} \\ {J}_{21}^{- 1} & {J}_{22}^{- 1}\end{matrix} ] .$$

By [Jₑ], we can define a relation between the two spaces, and further simplify the integrations as follows

$${\int }_{{S}_{physical}} \int ⅆ S = {\int }_{{S}_{virtual}} \int det [ {J}_{e} ] ⅆ S = {\int }_{- 1}^{1} {\int }_{- 1}^{1} det [ {J}_{e} ] ⅆ ξ ⅆ η$$

where

$$det [ {J}_{e} ] = \vert \begin{matrix}{\sum }_{j = 1}^{4} {r}_{j} \frac{ⅆ {N}_{j}}{ⅆ ξ} & {\sum }_{j = 1}^{4} {z}_{j} \frac{ⅆ {N}_{j}}{ⅆ ξ} \\ {\sum }_{j = 1}^{4} {r}_{j} \frac{ⅆ {N}_{j}}{ⅆ η} & {\sum }_{j = 1}^{4} {z}_{j} \frac{ⅆ {N}_{j}}{ⅆ η}\end{matrix} \vert .$$

According to the first principle of thermodynamics, the Rate of Conservation of Energy is expressed as follow,
(Rate of heat increased in V)=(Rate of heat conducted into V across S)+(Rate of heat generated within V) (1)
where V is a studied volume, S is a surface that envelops V.

Let u denote a specific internal energy of the object, then

Rate of heat increased in

$$V = {\int }_{V} ρ \frac{\partial u}{\partial t} ⅆ V$$

where ρ is a density of the object in kg/m³.

Introducing

$$c = \frac{ⅆ u}{ⅆ T}$$

(kJ/kg.K), we have

Rate of heat increased in

$$V = {\int }_{V}^{} ρ c \frac{\partial T}{\partial t} ⅆ V .$$

Using the Fourier's law of heat conduction, we can obtain an expression of the rate of heat conducted into V across S

$$q = - k ( grad ( T ) ) n = - k \frac{\partial T}{\partial n}$$

where k is a thermal conductivity of the object (W/m.K) which is assumed to be constant in V;

n is a normal direction of the surface S;

q is a flux of heat along n-direction.

So we obtain

$$\begin{matrix}\begin{matrix}Rate of heat conducted \\ into V arcoss S\end{matrix} = {∮}_{S} - q ⅆ S \\ = {∮}_{S} kgrad ( T ) ndS \\ = {\int }_{V}^{} kdiv ( grad ( T ) ) ⅆ V .\end{matrix}$$

Assuming heat is generated at a rate Q per unit volume, then

Rate of heat generated within

$$V = {\int }_{V}^{} Q ⅆ V$$

where Q=\dot{w} is a rate of heat transferred per unit volume, and

$$w = {\int }_{t}^{} \dot{w} ⅆ t$$

is a heat transferred per unit volume.

So the conservation statement can be written as

$${\int }_{V}^{} ( ρ c \frac{\partial T}{\partial t} - kdiv ( grad ( T ) ) - \dot{w} ) ⅆ V = 0.$$

Since the volume V was optionally chosen at the beginning, a boundary condition is expressed as,

$$ρ c \frac{\partial T}{\partial t} = kdiv ( grad ( T ) ) + \dot{w} = k {∇}^{2} T + \dot{w} .$$

The boundary condition should be used during the solution of the conservation equation (1) obtained in the previous section.

The lower surface (Γ₁ with the normal vector n₁ thereof) of the object is in contact with the die during the process. For the time t=0, Tₚₐᵣₜ=T_{die}=Tₐᵢᵣ, we assume a surface energy consumption due to a friction is

$$- k \frac{\partial T}{\partial {n}_{1}} = {h}_{part / die} ( T - {T}_{die} ) - \frac{b}{b + {b}_{die}} τ {v}_{s}$$

where h is a heat-exchanging coefficient when the die is at a temperature Tdie, b and b_{die} are effusivity (efffusivity=\sqrt{kρc}) of the object and of the die, respectively, τ is a friction stress, and vₛ is a relative speed between the die and the object.

The upper surface of the object is in contact with the air (Γ₃ with the normal vector n₃ thereof). For t=0, Tₚₐᵣₜ=Tₐᵢᵣ, we can approximate a radiation and a convection thereof by

$$- k \frac{\partial T}{\partial {n}_{3}} = {h}_{conv} ( T - {T}_{air} ) + {ɛ}_{r} {σ}_{r} ( {T}^{4} - {T}_{0}^{4} )$$

where εᵣ is a emissivity, σᵣ is a Stefan constant, Tₐᵢᵣ is a outside temperature, and h_{conv} is a heat-exchanging coefficient due to air convection.

Heat transferred between the object and the surrounding air can be modeled according to conduction (when the temperature difference between the air and the object is not large enough to move the air). Thus, a current is generated by a natural convection. In addition, we can simplify the problem by ignoring the radiation, so

$$- k \frac{\partial T}{\partial {n}_{3}} = {h}_{part / air} ( T - {T}_{air} ) .$$

We assume that a heat flux cross the element is q. A rate of the heat flux, which is unknown, can be estimated by using the shape functions,

$$\dot{q} = {\sum }_{j} {N}_{j} {\dot{q}}_{j} = \{ {N}_{j} \} \{ \dot{q} \} .$$

Therefore, the conduction equation is expressed as

$$- k \frac{\partial T}{\partial n} = \dot{q}$$

where n={hd 2; n₄}

When t=0, we can also assume that the initial values of the heat flux and the rate thereof are equal to 0 at any point of the object.

By using the Galerkin's method, we obtain a new form of the equation

$$\int {N}_{i} ( k \frac{{\partial }^{2} T}{\partial {r}^{2}} + k \frac{{\partial }^{2} t}{\partial {z}^{2}} + \frac{k}{r} \frac{\partial T}{\partial r} + \dot{w} - ρ c \frac{\partial T}{\partial t} ) rdrd θ ⅆ z = 0.$$

Performing integration on the first two terms of the new equation

$$\int {N}_{i} k \frac{{\partial }^{2} T}{\partial {r}^{2}} rdrd θ ⅆ z = \int {krN}_{i} \frac{\partial T}{\partial r} d θ ⅆ z - \int k \frac{\partial T}{\partial r } \frac{\partial ( {N}_{i} r )}{\partial r} drd θ ⅆ z$$

$$\int {N}_{i} k \frac{{\partial }^{2} T}{\partial {r}^{2}} rdrd θ ⅆ z = \int {krN}_{i} \frac{\partial T}{\partial r} d θ ⅆ z - \int k \frac{\partial T}{\partial r} ( r \frac{\partial {N}_{ i}}{\partial r} + {N}_{ i} ) drd θ ⅆ z$$

$$\int {N}_{i} k \frac{{\partial }^{2} T}{\partial {z}^{2}} rdrd θ ⅆ z = \int {krN}_{i} \frac{\partial T}{\partial z} d θ ⅆ r - \int k \frac{\partial T}{\partial z} r \frac{\partial {N}_{i}}{\partial z} drd θ ⅆ z$$

we obtain

$$\int {krN}_{i} \frac{\partial T}{\partial r} d θ ⅆ z + \int {krN}_{i} \frac{\partial T}{\partial z} d θ ⅆ r - \int ( k \frac{\partial {N}_{i}}{\partial r} \frac{\partial T}{\partial r} + k \frac{\partial {N}_{i}}{\partial z} \frac{\partial T}{\partial z} {N}_{i} \dot{w} - {N}_{i} ρ c \frac{\partial T}{\partial t} ) rdrd θ ⅆ z = 0.$$

We can simplify the equation according to the independence of θ. Then, the results of the geometrical modeling are

$$r = {\sum }_{j} {N}_{j} {r}_{j} = \{ {N}_{j} \} \{ r \}$$

$$z = {\sum }_{j} {N}_{j} {z}_{j} = \{ {N}_{j} ] \{ z \}$$

$$T = {\sum }_{j} {N}_{j} {T}_{j} = \{ {N}_{j} \} \{ T \}$$

$$drdz = det [ J ] d ξ d η$$

$$\frac{\partial {N}_{i}}{\partial r} = {J}_{11 }^{- 1} \frac{\partial {N}_{i}}{\partial ξ} + {J}_{12}^{- 1} \frac{\partial {N}_{i}}{\partial η}$$

$$\frac{\partial {N}_{i}}{\partial z} = {J}_{21}^{- 1} \frac{\partial {N}_{i}}{\partial ξ} + {J}_{22}^{- 1} \frac{\partial {N}_{i}}{\partial η}$$

$$\frac{\partial T}{\partial r} = \{ \frac{\partial {N}_{j}}{\partial r} \} \{ T \}$$

$$\frac{\partial T}{\partial z} = \{ \frac{\partial {N}_{j}}{\partial z} \} \{ T \}$$

$$\{ {T}_{e} \} = \{ \begin{matrix}{T}_{1} \\ {T}_{2} \\ {T}_{3} \\ {T}_{4}\end{matrix} \}$$

$$\{ T \} = \{ \begin{matrix}{T}_{1} \\ {T}_{2} \\ ⋮ \\ ⋮ \\ {T}_{n}\end{matrix} \}$$

$$\int {krN}_{i} \frac{\partial T}{\partial r} ⅆ z + \int {krN}_{i} \frac{\partial T}{\partial z} ⅆ r - \int ( k \frac{\partial {N}_{i}}{\partial r} \frac{\partial T}{\partial r} + k \frac{\partial {N}_{i}}{\partial z} \frac{\partial T}{\partial z} + {N}_{i} \dot{w} - {N}_{i} ρ c \frac{\partial T}{\partial t} ) r det [ J ] d ξ ⅆ η = 0.$$

Taking the boundary conditions into account, we get

$$- {\int }_{{Γ}_{1}} {rN}_{i} {h}_{part / die} ( T - {T}_{die} ) ⅆ {Γ}_{1} - {\int }_{{Γ}_{3}} {rN}_{i} {h}_{part / air} ( T - {T}_{air} ) ⅆ {Γ}_{3} - {\int }_{{Γ}_{2}} {rN}_{i} {\dot{q}}_{2} ⅆ {Γ}_{2} - {\int }_{{Γ}_{4}} {rN}_{i} {\dot{q}}_{4} ⅆ {Γ}_{4} - \int ( k \frac{\partial {N}_{i}}{\partial r} \frac{\partial T}{\partial r} + k \frac{\partial {N}_{i}}{\partial z} \frac{\partial T}{\partial z} + {N}_{i} \dot{w} - {N}_{i} ρ c \frac{\partial T}{\partial t} ) r det [ J ] d ξ ⅆ η = 0.$$

Since Γᵢ represents two nodes of a linear element (an interpolation of the linear element is linear), we can compute dΓᵢ as

$$d {Γ}_{i} = \sqrt{{( \frac{ⅆ r}{ⅆ ξ} )}^{2} + {( \frac{ⅆ z}{ⅆ ξ} )}^{2}} d ξ , = - 1 \text{for} i = 1 and η = 1 for i = 3 ;$$

$$d {Γ}_{i} = \sqrt{{( \frac{ⅆ r}{ⅆ η} )}^{2} + {( \frac{ⅆ z}{ⅆ η} )}^{2}} d η , ξ = 1 for i = 2 and ξ = - 1 for i = 4 ,$$

that is

$$d {Γ}_{1} = \frac{1}{2} \sqrt{{( {r}_{1} - {r}_{2} )}^{2} + {( {z}_{1} - {z}_{2} )}^{2}} d ξ$$

$$d {Γ}_{2} = \frac{1}{2} \sqrt{{( {r}_{2} - {r}_{3} )}^{2} + {( {z}_{2} - {z}_{3} )}^{2}} d η$$

$$d {Γ}_{3} = \frac{1}{2} \sqrt{{( {r}_{3} - {r}_{4} )}^{2} + {( {z}_{3} - {z}_{4} )}^{2}} d ξ$$

$$d {Γ}_{4} = \frac{1}{2} \sqrt{{( {r}_{4} - {r}_{1} )}^{2} + {( {z}_{4} - {z}_{1} )}^{2}} d η .$$

These equations can be rewritten as the following forms

$${M}_{e} \frac{ⅆ \{ {T}_{e} \}}{ⅆ t} + {K}_{e} \{ {T}_{e} \} = {f}_{e} + {{q}^{\hat{.}}}_{e}$$

where

$${M}_{e , ij} = \int ρ c {N}_{i} {N}_{j} \{ {N}_{k} \} \{ r \} ⅆ et [ J ] ⅆ ξ ⅆ η$$

$$\begin{matrix}{K}_{e , ij} = - \int {h}_{part / die} \{ {N}_{k} \} \{ r \} {N}_{i} {N}_{j} ⅆ {Γ}_{1} - \int {h}_{part / air} \{ {N}_{k} \} \{ r \} {N}_{i} {N}_{j} ⅆ {Γ}_{3} - \\ \int k \{ {N}_{k} \} \{ r \} ( \frac{\partial {N}_{i}}{\partial r} \frac{\partial {N}_{j}}{\partial r} + \frac{\partial {N}_{i}}{\partial r} \frac{\partial {N}_{j}}{\partial z} ) ⅆ et [ J ] ⅆ ξ ⅆ η\end{matrix}$$

$${\dot{\hat{q}}}_{e , i} = {\int }_{{Γ}_{2}} {rN}_{i} {\dot{q}}_{2} ⅆ {Γ}_{2} + {\int }_{{Γ}_{4}} {rN}_{i} {\dot{q}}_{4} ⅆ {Γ}_{4} .$$

By using the numerical method to express the rate of the heat flux, we obtain

$${\dot{\hat{q}}}_{e , i} = {\sum }_{k = 1}^{{Nb}_{nodes}} ( ( {\int }_{{Γ}_{2}} {rN}_{i} {N}_{k} ⅆ {Γ}_{2} ) {\dot{q}}_{2 , k} + ( {\int }_{{Γ}_{4}} {rN}_{i} {N}_{k} ⅆ {Γ}_{4} ) {\dot{q}}_{4 , k} )$$

where \dot{q}_{j,k} is an unknown rate of the heat flux taken through the bound Γⱼ at the node k, and for Γ₂, ξ=1, for Γ₄, ξ=−1. Note that the rate of the heat flux is taken in a direction normal to the bound towards outside, thus
ƒ_{e,i}=∫Nᵢ\dot{w}{Nₖ}{r}det[J]dξdη−∫h_{part/die}{Nₖ}{r}NᵢT_{die}dΓ₁−∫h_{part/air}{Nₖ}{r}NᵢTₐᵢᵣdΓ₃.

If \dot{w} is represented by Lagrange interpolation over a Ω space, an approximation of

$${\int }_{Ω} \dot{w} {N}_{i} ⅆ Ω = {\sum }_{j = 1}^{{n}_{N}} ( {\int }_{e} {N}_{j} {N}_{i} ⅆ Ω ) {\dot{w}}_{j}$$

can be employed to simplify the evaluation of {ƒ}.

Then, we have the following relation between \dot{w}, σ and \dot{ε}
\dot{w}ⱼ=Σσ_{i,j}\dot{ε}_{i,j}.

And,

$$\begin{matrix}{f}_{e , i} = {\sum }_{j = 1}^{4} ( \int {N}_{j} {N}_{i} \{ {N}_{k} \} \{ r \} ⅆ et [ J ] ⅆ ξ ⅆ η ) {\dot{w}}_{j} \\ - \int {h}_{part / die} \{ {N}_{k} \} \{ r \} {N}_{i} {T}_{die} ⅆ {Γ}_{1} - \int {h}_{part / air} \{ {N}_{k} \} \{ r \} {N}_{i} {T}_{air} ⅆ {Γ}_{3}\end{matrix}$$

where σⱼ and \dot{ε}ⱼ, stress and strain are obtained at the node j. The sum of the principle components

$${\dot{w}}_{j} = {\sum }_{i = 1}^{3} {σ}_{i , j} {\dot{ɛ}}_{i , j} ,$$

where i={1, 2, 3}) is the principal direction of strain and stress.

Therefore, the temperature value at each node is obtained, so that we can further obtain the temperature distribution of the object.

Although the present invention preferably employs a two dimensional FEA with four-node quadrilateral elements, other suitable types of finite element analyses, such as three dimensional FEA, may be used to provide a temperature distribution. Moreover, the procedure of the calculation can be executed by a computer or a microprocessor.

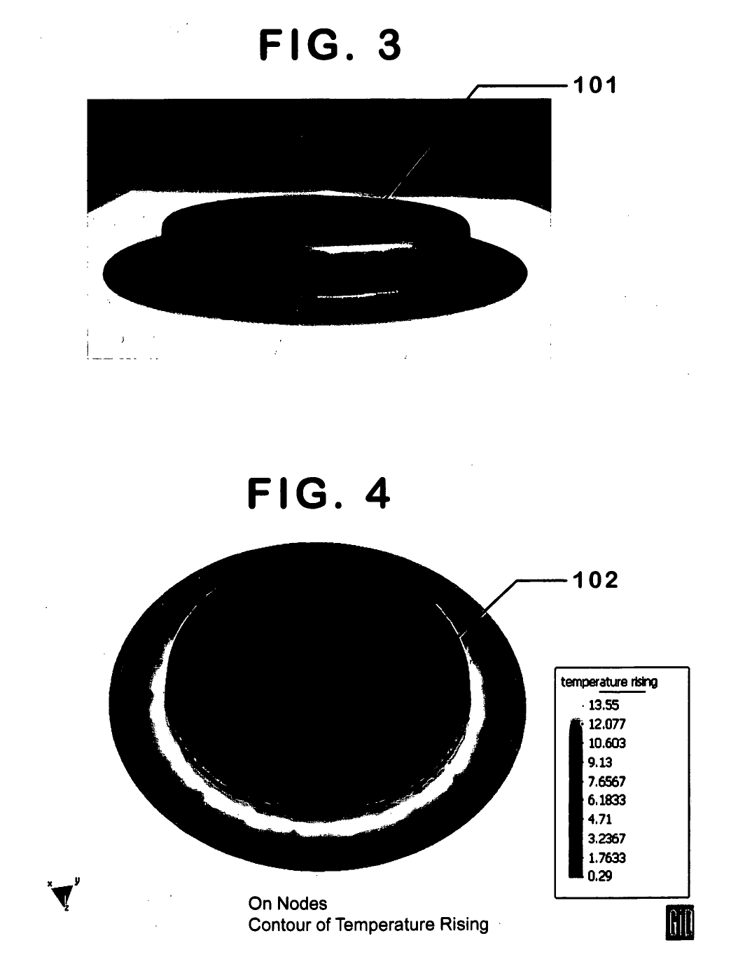

FIG. 3 shows a cup 101 made by an one-step stamping process. By using the FEA of the present invention, a calculated temperature distribution 102 of the cup 101 is shown in FIG. 4.

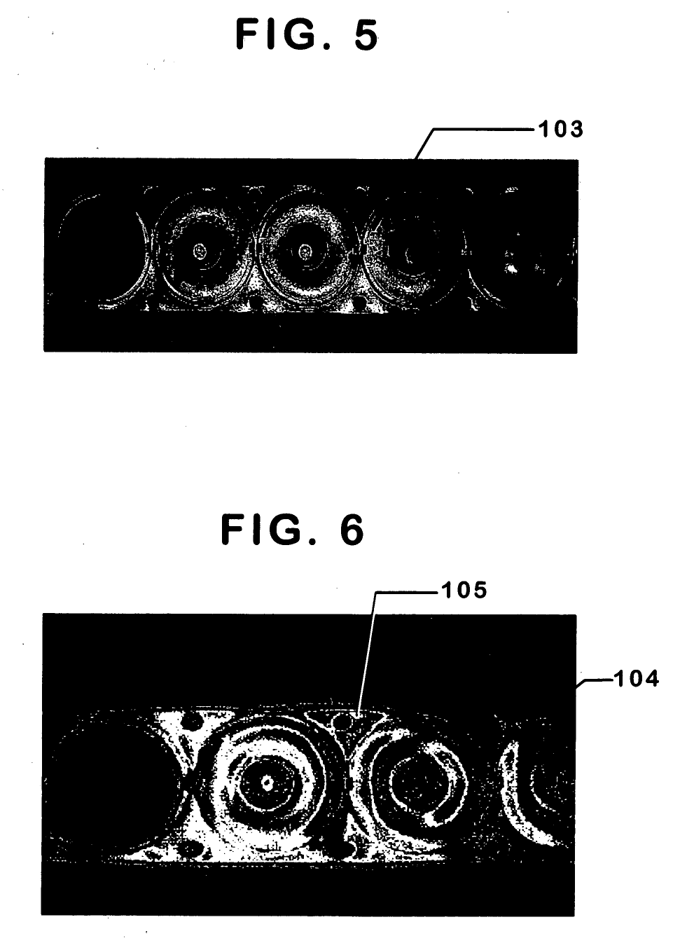

As described above, it is possible to identify a potential defect of a simple object by analyzing one or more thermal images captured. FIG. 5 shows such a typical workpiece 103 made by progressive stamping process. FIG. 6 shows a 2D thermal image 104 captured by an infrared camera (Manufacturer: Guide, Model: IR913) reflecting the temperature value of the object. As shown in FIG. 6, there exists a high temperature spot 105 that indicates an exceptional deformation of the workpiece 103. It is possible to assume there is a manufacturing error of the die at a position corresponding to the spot, which may cause an additional friction thereby generating a relatively high temperature. As a result, the object is stamped exceeding the dimension deviation.

However, if the object is of a relatively complex structure, further analysis should be carried out to inspect the problems. Firstly, the temperature distribution of the object after stamping is calculated by means of the FEA method. Secondly, the thermal images of the object after stamping are captured (the thermal images of the present invention can be obtained by any conventional techniques, such as an infrared camera or the like). Then, we can inspect defects of the object as well as the reason for the defects by comparing the thermal images with the calculated temperature distribution of the object.

Moreover, if the object is too complex to be inspected by using the thermal images, we can reconstruct a 3D temperature distribution by combining the captured 2D thermal images of the object, so as to inspect defects of the object by comparing the reconstructed temperature distribution with the calculated one.

Although a visual inspection can also identify a distortion exceeding a dimension tolerance, it reveals no information on which causes the problem. Even using an on-line monitoring system, it is also difficult to identify the causes of the problem. However, according to the present invention, by using the FEA to analyze the temperature distribution of the workpiece after progressive stamping, it is possible to understand which causes the distortion by analyzing an abnormal position in the temperature distribution of the object.

In practice, the operation for obtaining the thermal images is a complicated task for the reason that electromagnetic radiation may cross a rather wide spectrum and thereby interfere with each other. In other words, the thermal images may be affected by various noises, such as the surrounding light, the reflection, the body heat of the operators and the nearby machines.

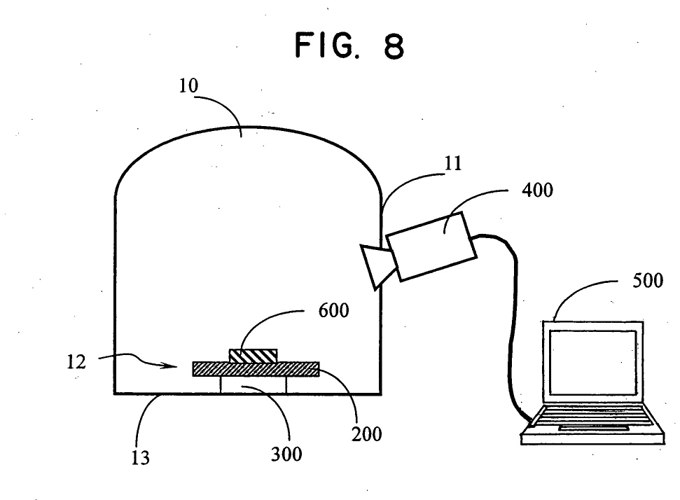

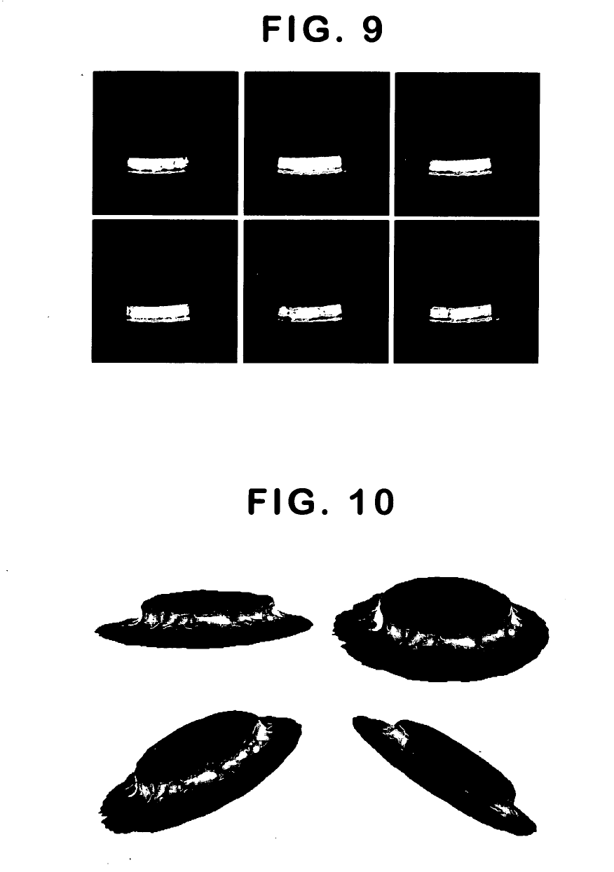

FIG. 8 shows an embodiment of the apparatus of the present invention, which comprises an adiabatic shell 10. The adiabatic shell 10 is generally made of thermal isolated materials, which is provided for enclosing an object to be stamped. The configuration of the adiabatic shell 10 is carefully designed to avoid heat loss of the object. Therefore, the thermal images captured can reflect the actual temperature distribution of the object in a relatively accurate manner. For example, the adiabatic shell is designed to be a spherical shape with smooth inner face. In order to reduce the heat loss due to the convection, the method of the present invention is preferably suitable to be applied to an object immediately after stamping.

As shown in FIG. 8, the adiabatic shell 10 comprises at least one side wall 11 for mounting an infrared camera 400. The shell 10 further comprises a lower portion 12 and a bottom portion 13 within the inner thereof. A turntable 200 for supporting an object 600 is mounted on the lower portion 12 of the shell 10, and a motor 300 for driving the turntable 200 is mounted on the bottom portion 13 of the shell 10.

A computer 500 is provided and electrically coupled to the infrared camera 400. The analyzing data of the temperature distribution of the object 600, which is obtained according to the method of the present invention, is stored in the computer 500.

After capturing thermal images from different views by rotating the turntable 200 supporting the object 600, the images are transmitted to the computer 500 with simulating and analyzing software.

According to a method of the present invention, it is possible to reconstruct a 3D temperature distribution of an object. In order to improve the precision of the reconstruction, the inspecting system is firstly calibrated to obtain an exterior relationship between the turntable 200 and the camera 400 as well as an interior parameter of the camera 400, and then a series of 2D temperature distribution of an object is obtained from the captured images, finally a 3D temperature distribution of the object is reconstructed by means of a space-carving method.

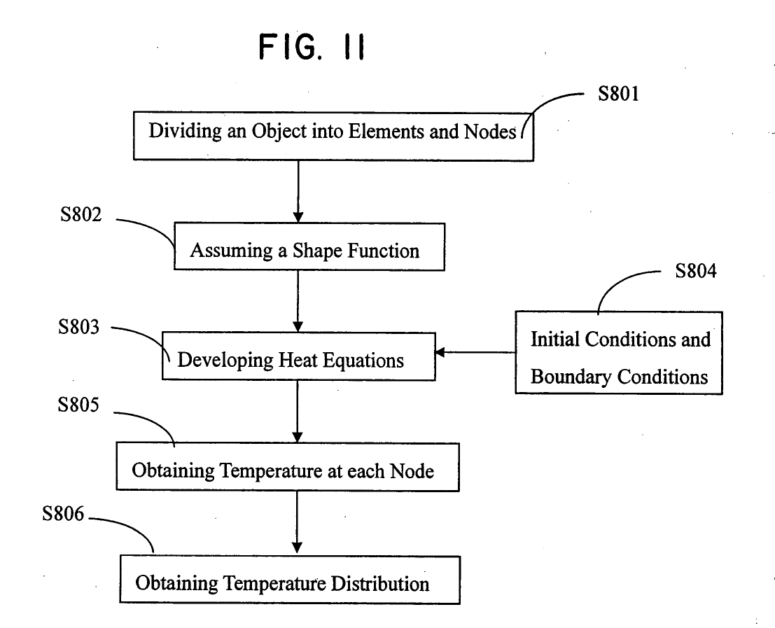

For example, in order to obtain the geometric shape and temperature distribution of the stamped cup 101 as shown in FIG. 3, totally 18 thermal images of the stamped cup 101 is captured, wherein 6 of the 18 thermal images are shown in FIG. 9. FIG. 10 shows a reconstructed temperature distribution of the cup 101 form different views. By comparing the reconstructed temperature distribution of the cup 101 with the calculated one as shown in FIG. 4, it is readily to inspecting the potential problems encountered during the stamping process. According to the present embodiment, the 3D temperature distribution of the cup 101 in FIG. 10 is similar to the calculated temperature distribution of the cup 101 in FIG. 4, which implies that there is no severe defect during the stamping.

Although a conventional FEA method can model a hypothetical situation, it cannot model the factors which can be considered by the present method, such as die surface finish, lubrication, and etc. The method of the present invention is different form the conventional FEA in that this method utilizes a temperature distribution of an object to inspect the stamping process by using a similarity between the actual strain and the temperature distribution of an object after stamping.

This present invention is preferably suitable to be used in high speed stamping and heat-assisted stamping process, in which the temperature control is an important factor.

Although the present invention and its advantages have been described in detail, those skilled in the art should understand that they can make various changes, substitutions and alterations herein without departing from the spirit and scope of the invention in its broadest form.

1. A method for inspecting an object after stamping, comprising:
obtaining one or more thermal images of the object after stamping; and
identifying defects existing in the object due to the stamping process by using the one or more thermal images,
wherein a non-smooth temperature gradient in the one or more thermal images indicates that defects exist in the object during the stamping process.

2. The method according to claim 1, wherein the one or more thermal images are obtained by an infrared camera.

3. The method according to claim 2, wherein the one or more thermal images comprises a plurality of infrared images, which are captured in different directions with respect of the object.

4. A method for inspecting an object after stamping, comprising:
determining a temperature distribution of an object after stamping;
obtaining one or more thermal images of the object after stamping; and
comparing the determined temperature distribution with the obtained thermal images so as to identify defects existing in the object after stamping,
wherein the difference between the temperature distribution and the thermal images indicates the presence of defects in the object.

5. The method according to claim 4, wherein the method further comprises:
reconstructing a temperature distribution of the object after stamping by combining the one or more thermal images; and
comparing the determined temperature distribution with the reconstructed temperature distribution so as to identify defects existing in the object after stamping, and the difference between the determined temperature distribution and the reconstructed temperature distribution indicates the presence of defects in the object.

6. The method according to claim 4, wherein said determining a temperature distribution of an object after stamping further includes modeling the temperature distribution of the object after stamping.

7. The method according to claim 6, wherein Finite Element Analysis is employed in said modeling the temperature distribution of the object after stamping.

8. The method according to claim 7, wherein the Finite Element Analysis method comprises:
creating and discretizing the object into finite elements, so that the object is sub-divided into elements and nodes;
assuming a shape function to represent the physical behaviour of each element;
developing heat equations for each element;
applying boundary conditions and initial conditions;
solving a set of algebraic equations simultaneously to obtain temperature values at different nodes; and
obtaining a temperature distribution of the object.

9. The method according to claim 8, wherein said developing heat equations for each element is based on the Law of Conservation of Energy, and the first principle of thermodynamics, which comprises the formula:
$${\int }_{V} ( ρ c \frac{\partial T}{\partial t} - kdiv ( grad ( T ) ) - \dot{w} ) ⅆ V = 0$$
where V is a studied volume of a element of the object;
$${\int }_{V} ρ c \frac{\partial T}{\partial t} ⅆ V$$
is a Rate of heat increased in V, ρ is a density of the object in kg/m³,
$$c = \frac{ⅆ u}{ⅆ T}$$
(kJ/kg.K), u denotes a specific internal energy of the object, T denotes the temperature, and t denotes the time;
$${\int }_{V} kdiv ( grad ( T ) ) ⅆ V$$
is a Rate of heat conducted into V across S, S is a surface that envelops V, k is a thermal conductivity of the object (W/m.K) which is assumed to be constant in V; and
$${\int }_{V} \dot{w} ⅆ V$$
is a Rate of heat generated within V, \dot{w} is a rate of heat transferred per unit volume.

10. The method according to claim 9, wherein the result of modeling the temperature distribution using the Finite Element Analysis is expressed as the formula:
$${M}_{e} \frac{ⅆ \{ {T}_{e} \}}{ⅆ t} + {K}_{e} \{ {T}_{e} \} = {f}_{e} + {\hat{\dot{q}}}_{e}$$
where V is a studied volume of a element of the object;
Mₑ is a matrix of 4×4 with M_{e,ij} as its elements,
M_{e,ij}=∫ρcNᵢNⱼ{Nₖ}{r}det[J]dξdη, i,j=1, 2, 3, or 4, −1≦ξ<1, −1≦η≦1, N₁ are the shape functions of four nodes in a virtual space of (ξ,η) system corresponding to a physical space of (r, z) system,
$${N}_{1} = \frac{( 1 - ξ ) ( 1 - η )}{4} , \\ {N}_{2} = \frac{( 1 + ξ ) ( 1 - η )}{4} , \\ {N}_{3} = \frac{( 1 + ξ ) ( 1 + η )}{4} , \\ {N}_{4} = \frac{( 1 - ξ ) ( 1 + η )}{4} , \\ r ( ξ , η ) = {N}_{1} {r}_{1} + {N}_{2} {r}_{2} + {N}_{3} {r}_{3} + {N}_{4} {r}_{4} , \\ z ( ξ , η ) = {N}_{1} {z}_{1} + {N}_{2} {z}_{2} + {N}_{3} {z}_{3} + {N}_{4} {z}_{4} , \\ det [ J ] = \vert \begin{matrix}{\sum }_{j = 1}^{4} {r}_{j} \frac{ⅆ {N}_{j}}{ⅆ ξ} & {\sum }_{j = 1}^{4} {z}_{j} \frac{ⅆ {N}_{j}}{ⅆ ξ} \\ {\sum }_{j = 1}^{4} {r}_{j} \frac{ⅆ {N}_{j}}{ⅆ η} & {\sum }_{j = 1}^{4} {z}_{j} \frac{ⅆ {N}_{j}}{ⅆ η}\end{matrix} \vert ;$$
Tₑ is a vector with T_{e,i} as its elements, i=1, 2, 3, 4;
Kₑ is a matrix of 4×4 with K_{e,ij} as its elements,
$$\begin{matrix}{K}_{e , ij} = - \int {h}_{part / die} \{ {N}_{k} \} \{ r \} {N}_{i} {N}_{j} ⅆ {Γ}_{1} - \\ \int {h}_{part / air} \{ {N}_{k} \} \{ r \} {N}_{i} {N}_{j} ⅆ {Γ}_{3} - \\ \int k \{ {N}_{k} \} \{ r \} ( \frac{\partial {N}_{i}}{\partial r} \frac{\partial {N}_{j}}{\partial r} + \frac{\partial {N}_{i}}{\partial r} \frac{\partial {N}_{j}}{\partial z} ) det [ J ] ⅆ ξ ⅆ η ,\end{matrix}$$
$$i , j = 1 , 2 , 3 , 4 ;$$
h_{part/die} is a heat-exchanging coefficient,
Γᵢ represents two nodes of a linear element, we can compute dΓᵢ as
$$ⅆ {Γ}_{i} = \sqrt{{( \frac{ⅆ r}{ⅆ ξ} )}^{2} + {( \frac{ⅆ z}{ⅆ ξ} )}^{2}} ⅆ ξ , η = - 1 for i = 1$$
$$and η = 1 for i = 3 , \\ ⅆ {Γ}_{i} = \sqrt{{( \frac{ⅆ r}{ⅆ η} )}^{2} + {( \frac{ⅆ z}{ⅆ η} )}^{2}} ⅆ η , ξ = 1 for i = 2$$
$$and ξ = - 1 for i = 4 ;$$
ƒₑ is a vector with ƒ_{e,i} as its elements,
$$\begin{matrix}{f}_{e , i} = {\sum }_{j = 1}^{4} ( \int {N}_{j} {N}_{i} \{ {N}_{k} \} \{ r \} det [ J ] ⅆ ξ ⅆ η ) {\dot{w}}_{j} - \\ \int {h}_{part / die} \{ {N}_{k} \} \{ r \} {N}_{i} {T}_{die} ⅆ {Γ}_{1} - \\ \int {h}_{part / air} \{ {N}_{k} \} \{ r \} {N}_{i} {T}_{air} ⅆ {Γ}_{3} ,\end{matrix}$$
T_{die} is the temperature of the die, Tₐᵢᵣ is the temperature of the air,
\dot{w}ⱼ=Σσ_{i,j}\dot{ε}_{i,j}, \dot{ε}_{i,j} is an emissivity, σ_{i,j} is a Stefan constant; and
\dot{\hat{q}}ₑ is a vector with \dot{\hat{q}}_{e,i} as its elements,
$${\hat{\dot{q}}}_{e , i} = {\int }_{{Γ}_{2}}^{} {rN}_{i} {\dot{q}}_{2} ⅆ {Γ}_{2} + {\int }_{{Γ}_{4}}^{} {rN}_{i} {\dot{q}}_{4} ⅆ {Γ}_{4} ,$$
\dot{q}_{j,k} is an unknown rate of the heat flux taken through the bound Γⱼ at the node k.

11. The method according to claim 4, wherein the one or more thermal images are obtained by means of an infrared camera.

12. An apparatus for inspecting an object after stamping, which comprises:
a device to obtain one or more thermal images of an object after stamping;
a data processing device, which is electrically coupled to said device for obtaining thermal images of the object after stamping, for inspecting the object by observing a non-smooth temperature gradient in the thermal images.

13. The apparatus according to claim 12, wherein the device to obtain thermal images of the object after stamping includes:
a support mechanism, for supporting and fixing the object;
an infrared camera, for taking thermal images of the object and transferring the images to said data processing device.

14. The apparatus according to claim 13, wherein said device to obtain thermal images of the object after stamping further comprises an adiabatic shell, which comprises at least one side wall for mounting the infrared camera.

15. The apparatus according to claim 12, wherein said device to obtain thermal images of the object after stamping further comprises a driving mechanism for driving said device to obtain one or more thermal images of an object after stamping.

16. An apparatus for inspecting an object after stamping, comprising:
a device for determining temperature distribution of the object after stamping by using Finite Element Analysis;
a device for obtaining one or more thermal images of an object after stamping;
a data processing device, which is electrically coupled to said device for determining temperature distribution of the object after stamping and said device to obtain thermal images of the object after stamping, for inspecting the object by comparing the determined temperature distribution with the thermal images.

17. The apparatus according to claim 16, wherein the data processing device is further employed to reconstruct a temperature distribution of the object after stamping by combining the thermal images, and to inspect the object by comparing the determined temperature distribution with the reconstructed temperature distribution.

18. The apparatus according to claim 16, wherein the device for obtaining one or more thermal images of the object after stamping includes:
a support mechanism, for supporting and fixing the object; and
an infrared camera, for taking thermal images of the object and transferring the images to said data processing device.

19. The apparatus according to claim 16, wherein said device for obtaining one or more thermal images of the object after stamping further comprises an adiabatic shell, comprising at least one side wall for mounting the infrared camera.

20. The apparatus according to claim 16, wherein said the device for obtaining one or more thermal images of the object after stamping further comprises a driving device for driving a support mechanism.
